(19) United States
(12) Patent Application Publication
(10) Pub. No.: US 2026/0134115 A1
(43) Pub. Date: May 14, 2026

(54) Deterministic Zero-Trust System For Enforcing Progressive Decision Irreversibility In Distributed Computing Environments

(71) Applicant: George William Bickerstaff, III, Greenwich, CT (US)

(72) Inventor: George William Bickerstaff, III, Greenwich, CT (US)

(21) Appl. No.: 19/442,502

(22) Filed: Jan. 7, 2026

(51) Int. Cl. G06F 21/60; G06F 21/54

(52) U.S. Cl. CPC G06F 21/604; G06F 21/54

(57) ABSTRACT

A deterministic zero-trust governance system intercepts execution requests at low-level system boundaries to prevent irreversible state changes. The system models decisions as commitment state machines, computes reversibility using deterministic decay functions, and enforces default-deny authorization prior to database commits or resource binding, thereby improving system reliability, security, and governance.

### FIELD OF THE INVENTION

The present invention relates to computer-implemented security and governance systems operating within distributed computing environments. More specifically, the invention relates to low-level execution control systems that prevent irreversible state changes in enterprise computing systems by deterministically computing decision reversibility and enforcing governance constraints at operating system, kernel, transaction, and execution-boundary layers prior to resource binding or database commitment.

### BACKGROUND OF THE INVENTION

Modern enterprise decisions are executed through sequences of computational actions rather than singular approvals, including database writes, transaction commits, system calls, API executions, contract finalizations, and resource allocations.

Although individual actions may appear reversible when viewed in isolation, their cumulative execution frequently results in irreversible system states such as committed financial obligations, executed legal agreements, public disclosures, or exhausted operational resources.

Existing governance, workflow, and access-control systems operate primarily at the application or policy layer and evaluate actions discretely rather than cumulatively.

As a result, enterprises often detect governance failures only after irreversible system changes have already occurred, at which point remediation is costly or impossible.

There exists a need for a technical system that improves the operation of computing systems by preventing irreversible state transitions through deterministic, real-time enforcement at execution boundaries.

### SUMMARY OF THE INVENTION

The present invention provides a deterministic zero-trust governance system that enforces progressive decision irreversibility by intercepting execution requests at low-level system boundaries before irreversible computational effects occur.

Each governed decision is modeled as a commitment state machine whose state evolves as commitment events are ingested from heterogeneous enterprise systems.

A multidimensional commitment state vector accumulates commitment values across independent dimensions including financial, contractual, operational, reputational, and temporal dimensions.

A Reversibility Score Computation Engine applies deterministic decay functions to the commitment state vector to compute a continuous reversibility score representing remaining decision optionality.

An Execution Authorization Gate enforces a default-deny zero-trust posture by blocking execution requests unless the reversibility score remains within predefined governance thresholds.

Enforcement occurs prior to database commits, resource binding, transaction finalization, or external side effects, thereby improving system integrity and preventing irreversible states.

### TECHNICAL CHARACTER AND COMPUTER SYSTEM IMPROVEMENTS

The invention improves computer functionality by preventing inconsistent or unauthorized system states in distributed computing environments.

Unlike application-layer governance systems, the Execution Authorization Gate operates at execution-boundary layers including operating system kernels, database transaction managers, API gateways, middleware interceptors, and privileged execution interfaces.

In one embodiment, the Execution Authorization Gate intercepts system calls or transaction commit instructions and suspends execution until authorization is granted by the Reversibility Score Computation Engine.

By preventing irreversible database writes and resource bindings before they occur, the invention improves transactional consistency, system reliability, and security.

### SYSTEM ARCHITECTURE

### Decision Registration Module

Each enterprise decision is registered as a commitment state machine with defined irreversibility thresholds, decay parameters, and authorization policies.

Registration occurs prior to any execution capable of producing irreversible system effects.

### Commitment Event Ingestion Engine

The Commitment Event Ingestion Engine integrates with heterogeneous enterprise systems including ERP systems, financial platforms, legal contract systems, procurement platforms, disclosure systems, and regulatory filing systems.

A normalization layer converts heterogeneous events into standardized commitment events.

For example, a signed contract and a bank transfer are normalized into comparable commitment increments within the commitment state vector.

### Commitment State Vector Generator

The commitment state vector is a multidimensional numerical structure representing accumulated commitment across independent dimensions.

Each dimension is incremented deterministically based on normalized event attributes.

### Deterministic Reversibility Decay Functions

The Reversibility Score Computation Engine applies deterministic decay functions to the commitment state vector.

In one embodiment, the reversibility score R is computed as a deterministic function of accumulated commitment across multiple dimensions according to the following expression:

$$R = 1 - Σ ( {w}_{i} \times {f}_{i} ( {c}_{i} , t ) ) ,$$

where wᵢ represents a weighting factor for commitment dimension i, cᵢ represents an accumulated commitment value for dimension i, t represents elapsed time, and fᵢ represents a deterministic decay function associated with dimension i.

Representative decay functions include linear, exponential, and logarithmic functions applied differently across commitment dimensions.

These functions ensure predictable and repeatable reversibility computation suitable for deterministic enforcement.

### Irreversibility Control Model

Threshold detection logic continuously evaluates reversibility scores against predefined boundaries.

Authorization escalation is triggered as thresholds are approached.

When thresholds are exceeded, a commitment lock mechanism prevents further execution.

### Zero-Trust Enforcement Architecture

The system operates under a default-deny zero-trust posture.

No execution request capable of modifying system state is permitted unless explicitly authorized by the Reversibility Score Computation Engine.

Authorization is re-evaluated for each execution request, ensuring continuous enforcement.

### Governance Enforcement and Audit

All intercepted executions and authorization decisions are recorded in an immutable audit log.

Cryptographic actor attribution binds each execution attempt to a verified identity.

### Use-Case Specific Embodiments

In one embodiment, the system governs mergers and acquisitions by tracking due diligence, financing, regulatory, and disclosure commitments.

In another embodiment, the system governs large-scale procurement by tracking contractual, budgetary, and delivery commitments.

In another embodiment, the system governs regulatory compliance filings by preventing unauthorized irreversible submissions.

### BRIEF DESCRIPTION OF THE DRAWINGS

FIG. 1—SYSTEM OVERVIEW illustrates the overall architecture of the deterministic governance system. The figure shows decision registration, event ingestion, reversibility computation, and execution enforcement. This establishes end-to-end decision control.

FIG. 1A—DECISION REGISTRATION illustrates initialization of a decision as a commitment state machine. Governance parameters are defined prior to execution. This ensures early constraint enforcement.

FIG. 1B—EVENT INGESTION illustrates collection and normalization of commitment events. Events are validated and standardized. This enables consistent downstream processing.

FIG. 1C—STATE VECTOR illustrates construction of the multidimensional commitment state vector. Events increment vector dimensions deterministically. This provides quantitative commitment tracking.

FIG. 1D—REVERSIBILITY SCORE illustrates calculation of a continuous reversibility score. Deterministic decay functions are applied. The score reflects remaining decision optionality.

FIG. 1E—EXECUTION GATE illustrates interception of execution requests. Requests are authorized or blocked prior to irreversible effects. This enforces zero-trust execution control.

FIG. 2—COMMITMENT MODEL illustrates progressive commitment accumulation. Individual actions combine into irreversible outcomes. This model supports reversibility analysis.

FIG. 2A—STATE MACHINE illustrates deterministic state transitions. Each transition reduces reversibility. This formalizes commitment progression.

FIG. 2B—VECTOR DIMENSIONS illustrates independent commitment dimensions. Each dimension represents a different irreversibility source. This enables granular analysis.

FIG. 2C—DIMENSION WEIGHTS illustrates weighting of commitment dimensions. Weights affect reversibility computation. This reflects governance priorities.

FIG. 2D—EVENT ACCUMULATION illustrates cumulative impact of multiple events. Minor events collectively reduce reversibility. This highlights non-linear effects.

FIG. 2E—TEMPORAL EFFECTS illustrates time-based irreversibility. Reversibility decreases with elapsed time. This captures delay-based risk.

FIG. 3—REVERSIBILITY CONTROL illustrates irreversibility detection and response. Threshold monitoring and forecasting are shown. This enables proactive enforcement.

FIG. 3A—DECAY FUNCTIONS illustrates deterministic decay models. Different functions represent different irreversibility behaviors. This ensures predictability.

FIG. 3B—THRESHOLD LOGIC illustrates threshold detection. Boundary crossings trigger enforcement. This prevents irreversible execution.

FIG. 3C—COMMITMENT LOCK illustrates execution lock activation. Further commitments are blocked. This halts irreversibility.

FIG. 3D—CONTRIBUTION ANALYSIS illustrates dimension-level irreversibility contributions. Dominant drivers are identified. This supports targeted intervention.

FIG. 3E—TRAJECTORY FORECAST illustrates future reversibility projections. Forecasting uses current trends. This enables planning.

FIG. 4—ENFORCEMENT LAYER illustrates low-level Execution enforcement. Interception, authorization, and logging are shown. Enforcement occurs pre-commit.

FIG. 4A—KERNEL INTERCEPT illustrates kernel-level interception. Execution pauses before state change. This ensures last-moment control.

FIG. 4B—DEFAULT DENY illustrates zero-trust Authorization. Execution is denied unless permitted. This enforces continuous control.

FIG. 4C—AUTH ESCALATION illustrates dynamic authorization escalation. Oversight increases as reversibility decreases. This protects high-risk decisions.

FIG. 4D—BLOCKING FLOW illustrates rejection workflows. Alerts and logs are generated. No irreversible action occurs.

FIG. 4E—AUDIT RECORD illustrates immutable audit logging. Records are tamper-resistant. This supports compliance.

FIG. 5—GOVERNANCE INTERFACE illustrates visualization tools. Dashboards and analytics are shown. This supports oversight.

FIG. 5A—SCORE DASHBOARD illustrates real-time reversibility display. Thresholds and trends are visible. This enables awareness.

FIG. 5B—DECISION VIEW illustrates per-decision analysis. Timelines and dimensions are shown. This supports review.

FIG. 5C—SIMULATION TOOL illustrates hypothetical scenario testing. Live state is unchanged. This enables forecasting.

FIG. 5D—RISK MAP illustrates enterprise-wide irreversibility risk. High-risk areas are highlighted. This supports strategy.

FIG. 5E—TIME ESTIMATE illustrates time-to-threshold projections. Estimates use decay functions. This enables intervention.

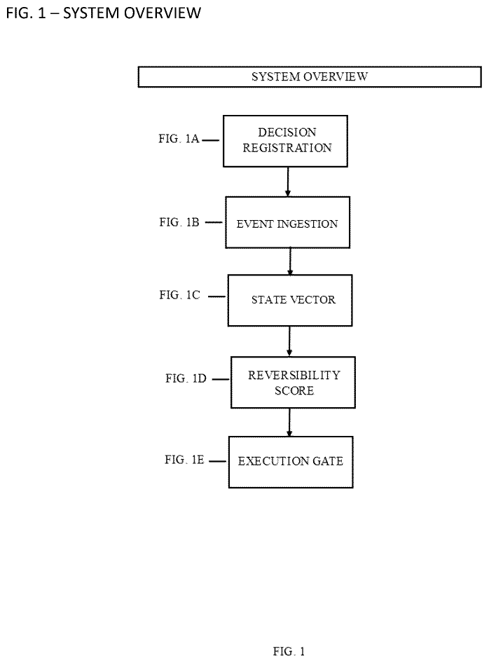

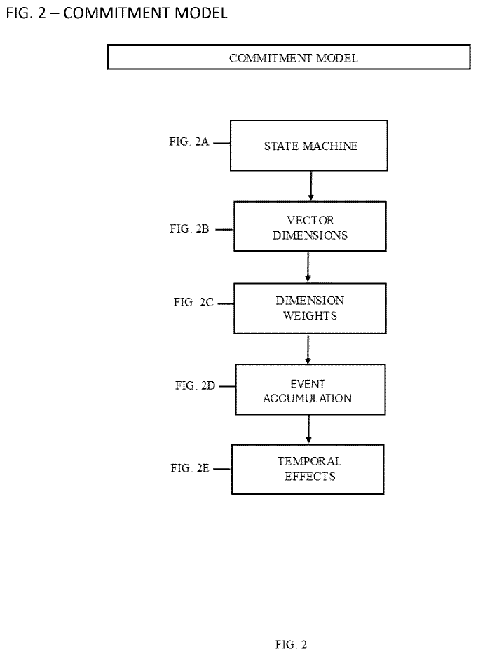

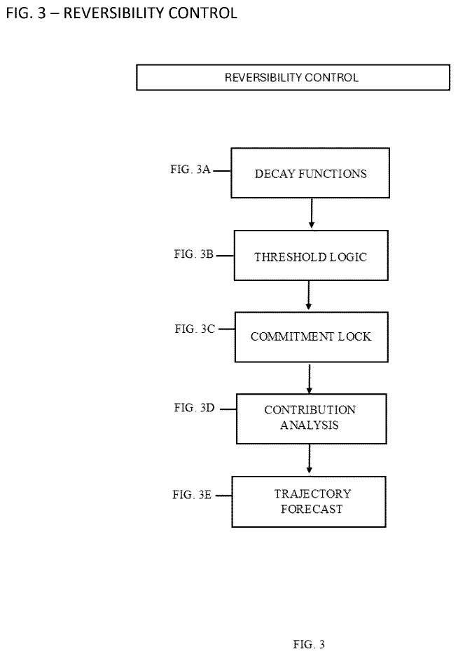

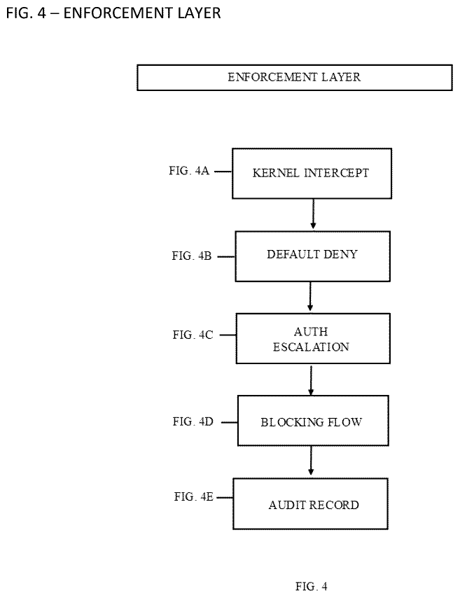

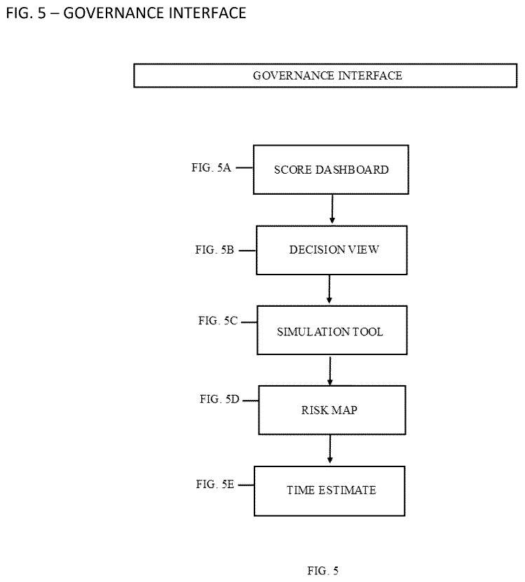

### DEFINITIONS

Action Execution Request means a request issued by a computing system, application, or process to perform an operation that may modify system state, consume resources, or produce irreversible effects, including database commits, transaction finalization, or resource binding.

Commitment Event means a normalized representation of an action, transaction, or occurrence that contributes to accumulated commitment within a governed decision and is derived from one or more heterogeneous enterprise systems.

Commitment State Machine means a deterministic computational model representing a governed decision as a sequence of states, wherein each state transition reflects an increase in accumulated commitment and a corresponding reduction in reversibility.

Commitment State Vector means a multidimensional numerical data structure that accumulates commitment values across multiple independent dimensions, each dimension corresponding to a distinct source of irreversibility.

Decay Function means a deterministic mathematical function applied to an accumulated commitment value and a time variable to model progressive loss of reversibility for a specific commitment dimension.

Execution Authorization Gate means a system component configured to intercept action execution requests at one or more execution-boundary layers and to permit, delay, escalate, or block execution based on a computed reversibility score.

Execution Boundary means a technical interception point within a computing system at which execution may be evaluated prior to producing irreversible effects, including kernel operations, transaction commit stages, middleware processing, or API invocation points.

Governance Threshold means a predefined boundary value associated with a reversibility score or commitment state, beyond which additional execution is restricted, escalated, or prohibited to prevent irreversible system states.

Reversibility Score means a deterministic scalar value computed from a commitment state vector using one or more decay functions and representing remaining optionality or reversibility of a governed decision.

Zero-Trust Authorization means an execution control posture in which no action execution request is permitted by default unless explicitly authorized at runtime based on current system state and governance constraints.

1. A computer-implemented method comprising:
registering a decision as a commitment state machine;
ingesting normalized commitment events from heterogeneous enterprise systems;
updating a multidimensional commitment state vector based on the normalized commitment events;
computing a deterministic reversibility score using predefined decay functions applied to the multidimensional commitment state vector;
intercepting execution requests at execution boundaries prior to irreversible effects;
applying a default-deny authorization policy based on the deterministic reversibility score; and
blocking execution when one or more governance thresholds associated with the deterministic reversibility score are exceeded.

2. A deterministic zero-trust governance system comprising:
a commitment state machine registry configured to register decisions as commitment state machines;
a heterogeneous event normalization engine configured to ingest and normalize commitment events from multiple enterprise systems;
a reversibility score computation engine configured to compute a deterministic reversibility score using predefined decay functions applied to a multidimensional commitment state vector;
an execution authorization gate operating at one or more execution-boundary layers and configured to intercept execution requests prior to irreversible effects; and
an immutable audit log configured to record execution attempts and authorization decisions.

3. A non-transitory computer-readable medium storing instructions that, when executed by one or more processors, cause the one or more processors to perform a method comprising:
registering a decision as a commitment state machine;
ingesting normalized commitment events from heterogeneous enterprise systems;
updating a multidimensional commitment state vector based on the normalized commitment events;
computing a deterministic reversibility score using predefined decay functions applied to the multidimensional commitment state vector;
intercepting execution requests at execution boundaries prior to irreversible effects;
applying a default-deny authorization policy based on the deterministic reversibility score; and
blocking execution when one or more governance thresholds associated with the deterministic reversibility score are exceeded.

4. The method of claim 1, wherein intercepting execution requests occurs prior to database commit operations.

5. The method of claim 1, wherein the commitment state machine governs merger and acquisition activities by tracking commitments associated with due diligence, financing, regulatory filings, or public disclosures.

6. The method of claim 1, wherein the commitment state machine governs large-scale procurement activities by tracking contractual, budgetary, and delivery-related commitments.

7. The method of claim 1, wherein the commitment state machine governs regulatory compliance filings by preventing irreversible submissions without authorization based on the deterministic reversibility score.

8. The method of claim 1, wherein the predefined decay functions differ across commitment dimensions represented in the multidimensional commitment state vector.
